(19) United States
(12) Patent Application Publication
(10) Pub. No.: US 2026/0250127 A1
(43) Pub. Date: Aug. 27, 2026

(54) PROTON RICH IONIC FLUID IN CHAINED POLYMER FORMAT

(71) Applicant: TegIpco, LLC, Dover, DE (US)

(72) Inventors: Nicholas Joseph Wilson Arvanitakis, Cochise, AZ (US); Chrisanthos Arvanitakis, Cochise, AZ (US)

(73) Assignee: TegIpco, LLC, Dover, DE (US)

(21) Appl. No.: 19/059,535

(22) Filed: Feb. 21, 2025

(51) Int. Cl. C01B 3/04; C01B 13/00

(52) U.S. Cl. CPC C01B 3/04; C01B 13/00

(57) ABSTRACT

Inductive electrostatic and magnetostatic forces produce a forced heterolysis or heterolytic fusion of common proton donors, which causes a rapid cleaving of electrons and separation predominately free hydrogen protons. This and other processes result in the construction of a monoclinic proton saturated lattice formed of a measurable concentration of protons, which is packaged in the form of a proton-rich ionic fluid (PRIF). The PRIF contains groups of protons in a chained polymer format. These processes result in a radical decrease of overall activation energy, and exponentially increase the conductivity and potential energy stored in the PRIF when use on its own but also when mixed with other fuels.

### BACKGROUND OF THE INVENTION

Atomic Hydrogen can be difficult to isolate. Consequently, an improved delivery mechanism for atomic hydrogen is desired.

### SUMMARY OF THE EMBODIMENTS

In the manufacturing and stabilization of a super-protonic conductive polymeric fluid, a singular hydrogen proton H₁+ is freed of its electrons and becomes available to participate in unusual and very novel combinations.

The forces required in manufacturing a super-protonic rich polymer will be an inductive static force, and magnetostatic force that will be recirculated through a set of reactors (AKA cylindrical tanks for holding liquid) that dissimilate the protons from the proton donor and forcibly maintain the fluid in an electron deprived polymeric state. After predetermined amounts of time, the resulting fluid becomes stabilized and can be shipped or stored without returning to its earlier state.

Embodiments described herein will demonstrate how each of the above-stated forces result in a forced heterolysis or heterolytic fusion, which causes a rapid cleaving of electrons and fragmentation of the proton donor thereby isolating a hydrogen proton (H₁+) in a free state which has no electron. This process also results in the construction of a super-protonic conductor that allows proton transport through Grothuss-like movement. However, note the final protonic polymer will have no water molecules in it and the term Grothuss mechanism is being used mainly explain and give examples for the mode of proton transfer or proton current inside the newly created protonic fluid.

Some of the electric characteristics of the fluids shown herein comprise negative maximum conductivity, negative resistance, near zero impedance, and energy-positive characteristics. These characteristics can be affirmed by independent objective testing and test-mechanisms described in more detail herein, particularly within Appendix B.

With respect to the embodiments, a common proton donating fluid can be referenced as the base input fluid, and a mixture of multiple fluids will be also known as a base fluid. In each reaction the proton that will be isolated will be a free hydrogen proton (hereinafter symbolized by (H₁+). This H₁+ proton will have no electrons and will float in a monoclinic crystal structure which remains intact within the proton polymer.

The fluidic proton polymer can have a singular moment of nomenclature such as H₅₃O, H₁₀₁O, and H₂₅₉O. These and other nomenclatures or atomic amounts can be affirmed by a variety of mechanisms, of which a prominent but non-limiting example is mass gas analysis. But as defined herein, the designated monoclinic cube will always have groupings of eight corners, therefore each singular cube will have eight defined nomenclature chains inside of it ensuring the proper density and mass of the polymer.
Example: assume each cubical structure==H₂₅₉O×8=H2₀₇₂O₈, from that it can be induced that his solution shows 2072 hydrogen atoms per 8 oxygen atoms which has a hydrogen mass of 94% atomically.

In the processes used to form these various embodiments, the base proton fluid undergoes a forced heterolysis or heterolytic fusion through inductive static and magnetic forces shearing it completely. This molecularly allows for the protons (H₁+) to be donated quickly and efficiently from the base fluid, which allows the fragmentation of the base fluids hydrogen protons to be redistributed and collected into a saturated protonic polymer. The manufacturing also comes from the reactor creating an inductive electrostatic and magnetostatic force which forces the removal and a de-localizing of electrons and on the second stage forces the reassembling of an extremely electron-deficient fluid and maintains a protonic cloud center in a monoclinic crystal cubical structure which remains intact even once removed from the reactor creating the shelf stable protonic polymer.

This examples base fluid in the embodiments can be any rich, hydrogen-donating fluid. A list of potential fluids can be found in Appendix C.

A list of all Appendices asserted herein is shown below.
APPENDIX A: test mechanisms affirming components of proton polymer 800;
APPENDIX B: ways of catching infringers of proton polymer 800;
APPENDIX C: non-limiting list of hydrogen-donating input fluids; and
APPENDIX D: Specification-only, not claims, but some potential items in a claim-like format.

### BRIEF DESCRIPTION OF THE DRAWINGS

Advantages of the embodiments will be apparent from the following detailed description of the exemplary embodiments thereof, which description should be considered in conjunction with the accompanying drawings in which like numerals indicate like elements, in which the figures provide additional embodiments and images related to the content described herein.

FIGS. 1A and 1B show non-limiting arrangements of reactor systems for producing a Proton-Rich Ionic Fluid (PRIF) according to the embodiments herein;

FIGS. 2, 3A, and 3B show example methods of operation of the reactor systems of FIGS. 1A and 1B;

FIGS. 4A, 4B, 4C, 5A, 5B, 5C, 5D, 6A, 6B, and 6C show detail of one or more recirculators;

FIGS. 7A-7B-7C show contrasting arrangements of alternate embodiments of reactor systems;

FIG. 7D shows a recirculator using information from a testing module;

FIGS. 8A-8B-8C show details of an example proton polymer;

FIG. 9A shows a Grothuss mechanism;

FIG. 9B shows a type of Grothuss movement along an example proton polymer;

FIG. 10 shows support for usage of the expression “metallic hydrogen”;

FIGS. 11A-11B-11C show energy gain provide by the PRIF; and

FIG. 12 shows ranges of activation voltages.

### DETAILED DESCRIPTION OF THE PREFERRED EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. As used herein, the word “exemplary” means “serving as an example, instance or illustration.” The embodiments described herein are not limiting, but rather are exemplary only. It should be understood that the described embodiments are not necessarily preferred or advantageous over other embodiments. Moreover, the terms “embodiments of the invention”, “embodiments” or “invention” do not require that all embodiments of the invention include the discussed feature, advantage or mode of operation.

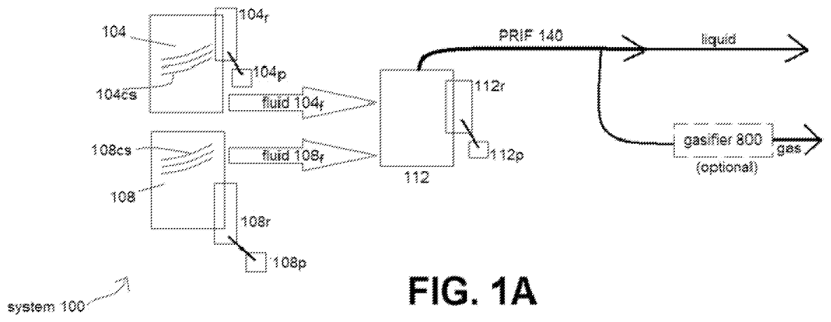

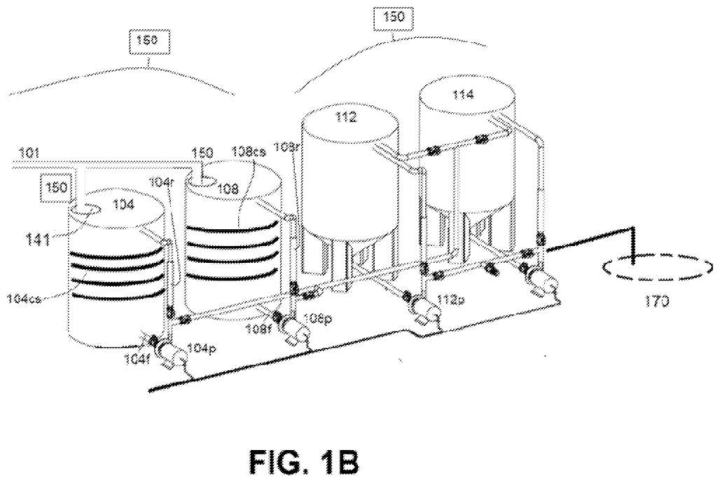

FIG. 1A shows an example system 100 for producing a proton-rich PRIF (PRIF) 140. The system 100 converts a common hydrogen-based input fluid 101 to the PRIF 140 comprising an overabundance of hydrogen H₁+ atoms, mainly just protons since atomic hydrogen does not have a neutron and the electron has been peeled off. This conversion occurs in the absence of elevated temperatures or pressures, so that the resulting PRIF 140 is suitable for shipping or storage at Standard Temperature and Pressure (STP, AKA Normal Temperature and Pressure NTP). One example period of reliable shelf-life of the PRIF 140 might be 36 months, although there could be examples of even longer shelf-life, depending on the specific formulation.

The input fluid 101 may be one of various commonly-found hydrogen-donating fluids or mixes of multiple hydrogen-donating fluids, and can also be dirty water, fracked water, and/or processed water. A non-limiting list of potential types of hydrogen-donating fluids can be found in an Appendix C to this disclosure, titled “EXAMPLE HYDROGEN-DONATING INPUT FLUIDS 101”.

Referring to FIGS. 1A and 1B, an example system 100 and flowchart includes a first tank 104, a second tank 108, a third tank 112, and corresponding recirculators 104r, 108r, 112r. Both first and second tanks 104\108 comprise recirculator 104r\108r, pump 104p\108p, and windings or inductor coils 104cs\108cs. Both first and second tanks also pump out intermediate fluids 104f\108f that has been partially-processed and is on its way to becoming the proton rich ionic fluid (PRIF) 140. FIG. 1B shows a fourth tank 114 which acts as a potential overflow tank, or storage tank, or other way of assisting in management of PRIF 140 during or after a production run thereof. In the flowcharts of FIGS. 1A-1B, all activity flows from left to right.

The tanks 104\108 have the circumferential windings 104cs\108cs applied to their outer surface thereby forming a reaction zone. The windings 104cs\108cs can be formed with stranded wire or other types of windings to act as a large-scale inductor coil. FIG. 1B also shows a seal 141 on the tank, and a detector 150. The tanks 104/108/112 can be operated at NTP/STP, but for detecting various gaseous components, the seal 141 could be helpful in trapping and capturing. The detector 150 can capture a lot of different components, as will be discussed in more detail herein.

The circumferential windings or inductor coils 104cs\108cs may be electrically coupled to a power supply so as to be electrically coupled to either alternating or direct current at a variety of frequencies. An amount of insulation on the wires and tanks, spacing between specific windings, and wire gauge all may vary according to a desired outcome.

The pumps 104p\108p are coupled to the recirculators 104r\108r which have magnetic modules 508 in various orientations attached thereto. However, the magnetic modules 508 can come in a lot of widely differing formats, of which the embodiments shown in the various FIGS herein are but non-limiting examples.

The activity within the reactor system(s) 100 result in removing electrons from the input fluid 101 in such a way that the resulting PRIF becomes electron-deficient. This PRIF 140 can remain electron deficient at STP for varying periods, e.g. having a shelf-life of 36 months.

The circumferential windings 104cs\108cs can have a variety of voltages and currents applied thereto. The voltage applied to the windings 104cs may be equal to that applied to the windings 108cs, or may not. Further, a voltage may be applied to one set of windings but not the other, and polarity may be altered.

A pre-determined wattage for the circumferential windings 104cs\108cs can be selected based on the chemical constituents of the input fluid 101, a desired configuration of the PRIF 140, ambient temperature, volume of end-product, and other factors. As current moves through windings 104cs\108cs, a corresponding magnetic field directed perpendicularly to windings 104cs\108cs applies a magnetostatic force to liquid 101 while being circulated through the tanks 104\108 for a predetermined period of time until the outlet fluid 104f\108f is transferred via e.g. to the 3^{rd} tank 112.

The magnetostatic forces applied to the windings 104cs\108cs can be adjusted between 2,000-80,000 Gauss, with 20,000-80,000 Gauss being a preferred range. When outlet openings 104f and 108f are opened, the fluids 104f\108f are combined into the third tank 112 which comprises a recirculator 112r and pump 112p. Once the fluid from both first tank 104 and second tank 108 are combined into the third tank 112, the combination is pumped and recirculated within the third tank 112.

Unlike the first tank 104 or second tank 108, third tank 112 does not have a circumferential windings, and therefore experiences no electrostatic effects. Instead, the third tank 112 experiences an oscillating magnetic field through the recirculator 112r due to the magnetic-modules 508 attached thereto.

During operation of the system 100, some oxygen vapes off, and goes away in a variety of forms. This is due to the fact that one purpose of the system 100 is to break the covalent bonds of a water molecule, separate out the oxygen\electrons and drive them off (prevent them from re-combining), and thus isolate protons in the form of H₁+. One reason this can be done at low power is because a typical water molecule is known to be a weak dipole, where some of the H can be separated from the O just by mechanical forces, some of which occur within the recirculators 104r/108r/112r.

The sensors 150 are used to affirm proper performance of the system 100, including temperature. In tank 104 there may be a slight exotherm 20-30 degrees F. based on which proton donor was used within the input fluid 101. Content of the specific chosen input fluid 101 can affect this, due to clean water v. dirty water v. produced water or other type of effluent source (see Appendix C).

Oxygen may gas off maybe 2-3% in overall mass difference, perhaps in the format of O2 but also in other formats. Various oxygen radicals are formed during production-use of the system 100, mostly oxygen based salts, which can vary according to a wide variety of conditions including but not limited to the content of the input fluid 101. These salts end up getting excreted through the back-end portion 170 of the system 100.

In a lower-cost embodiment, the detector 150 can be focused mainly on CO2 and O2, which both have special significance in hydrogen generation. However, the detector 150 can have wider scope, depending on manufacturing considerations and end-customer preferences.

If the input fluid 101 contains sulfuric acid, that can lead to sulfate salts, colloidal sulfur, and/or sulfur dioxide. Meanwhile, produced water tends to result in carbonates, oxides, and chloride salts. Acetic acid can lead to acetate salts.

The semicircle 170 represents a combination of filters, precipitate catch mechanisms, and or hydrocyclone, which may catch any of the below. That is, a non-limiting list of specific oxygen radicals and salts (either gas or solid) given off during use of the system 100 can include but are not limited to:
hydroxide salts (_OH); carbonate salts (_CO3);
sulfate salts (_SO4); nitric salts (_NO3);
dioxides (_O2), the most of important of which is CO2;
acetates (_CH3COO—); and alkoxides (_COH alcohol salts).

The proton-donating input fluid 101 (Appendix C) can comprise many different blends and even different waters and oils thus any of these will have different sludges and precipitates.

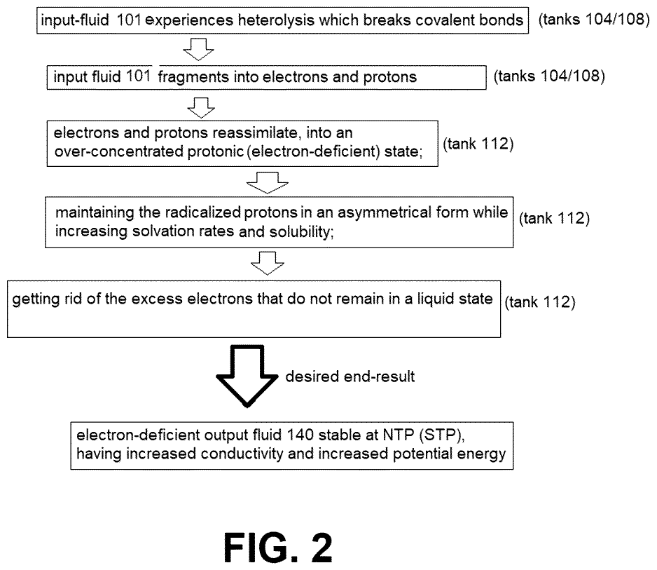

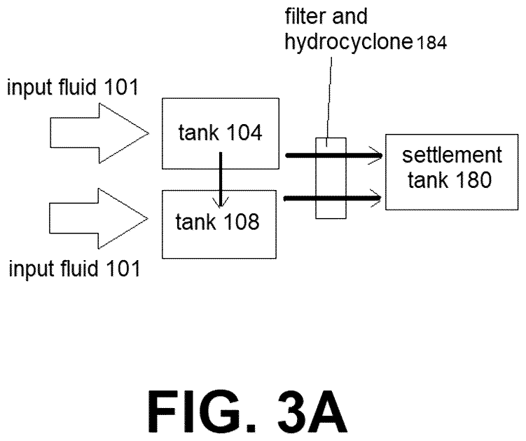

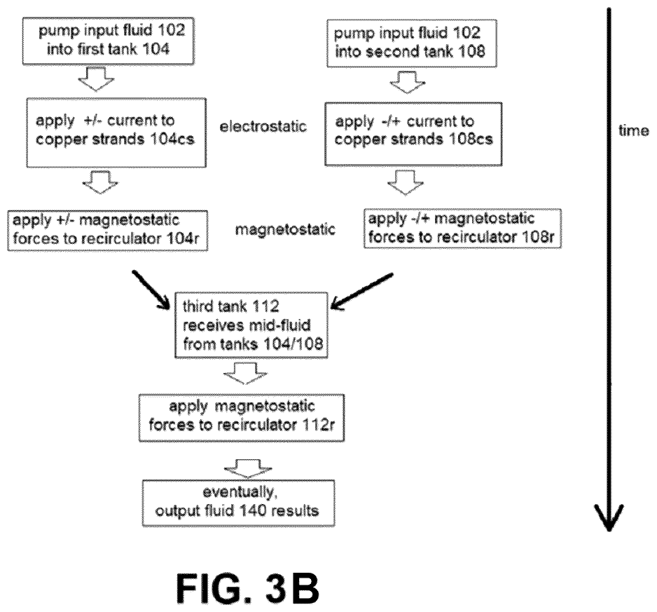

FIGS. 2 and 3A-3B show example methods of operation of the reactor systems of FIGS. 1A and 1B. Regarding the flowchart of FIG. 3A, in an embodiment, the second tank 108 might have twice the capacity of the first tank 104. An example operation of the flowchart of FIG. 3A might be where the tanks 104/108 are filled up with the input fluid 101 in equal proportions, and processed separately. The recirculators 104r/108r (not shown in FIG. 3A) could be set to opposite polarities. Then, the contents of tank 104 could be put into second tank 108 for further processing for predetermined time periods.

The second tank 108 might have the following elements added which may not be in the first tank 104: flocculants, polyacrylamides, ferric sulfates, and/or gypsum. An additional variation might be to add alcohol to the input of the first tank 104.

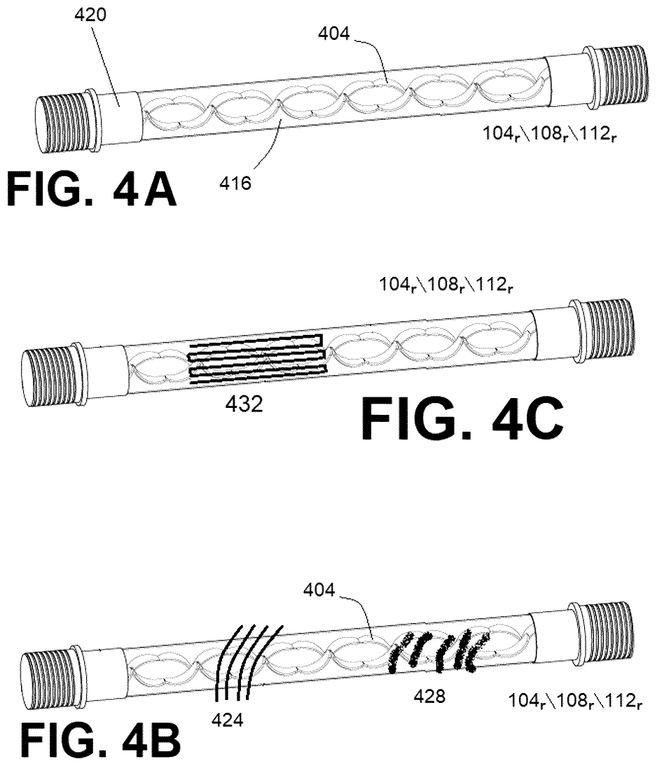

FIGS. 4A, 4B, 4C, 5A, 5B, 5C, 5D, 6A, 6B, and 6C show detail of the recirculators 104r, 108r, and 112r, which are sometimes referred to as static mixers. As shown at least within FIGS. 4A-4C, each recirculator can be formed as an elongated translucent tube that has movable internal fluting 404 (AKA baffle) located therein. The recirculators 104r, 108r, and 112r further comprise a grommet 420 at each end, along with threaded surfaces so that they may be connected in series. The internal fluting 404 aids in restraining fluid flowing through the tubes 416 thereby forming a type of reaction zone in which covalent bonds can be broken, and heterolysis can occur (FIG. 2). Each internal fluting 404 can be formed with a plurality of grommets 420 that can be concatenated to one another so as to form a chain structure if desired. The fluting 404 is important because it can break or at least strain the covalent bonds holding water together. It is an advantage of the embodiments herein to break the covalent bonds of the water with as little energy as possible. The fluting 404 leverages the fact that water molecule has weak dipole, a weak covalent bond.

FIG. 4B shows example windings 424 and inductor coils 428 embedded within the plexiglass body (tube 416) of a recirculator. These coils 428 are configurable at a variety of polarities and electromagnetic capabilities. FIG. 4C shows another example of inductor-patterning, where an inductive mechanism 432 is configured in a “rear window defogger” serpentine configuration.

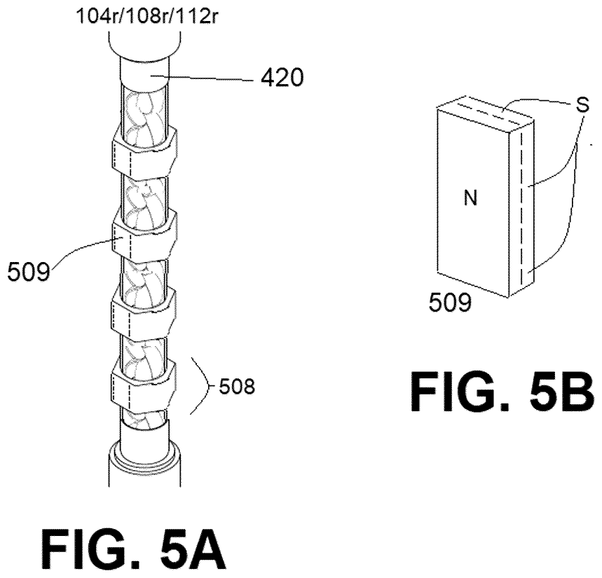

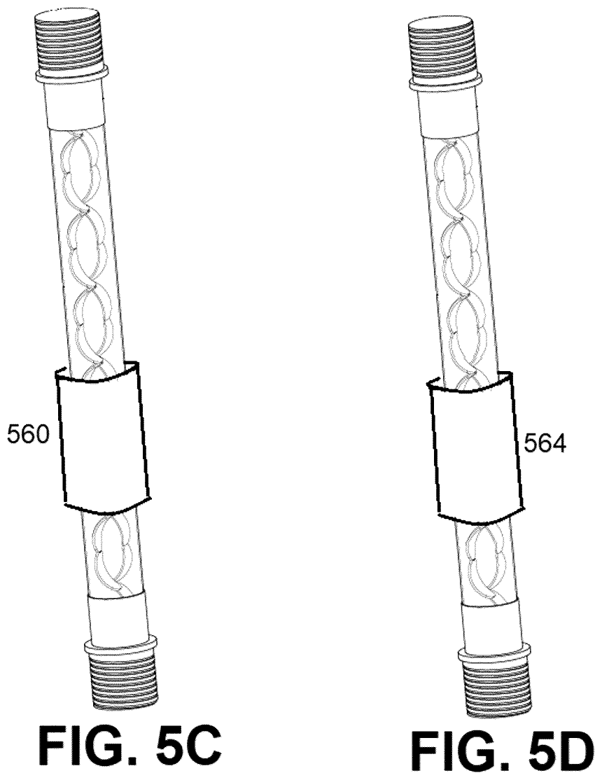

FIG. 5A shows an example recirculator with magnets 509 taped on. FIG. 5B shows an example of rectangular magnet 509 that is polarized in a way different than a domino magnet. FIG. 5C shows a recirculator with a slidable adjustable mechanical magnet-cuff 460. FIG. 5D shows a recirculator with a slidable adjustable electrical inductor-cuff 460.

The system 100 is designed to work in a variety of locations and climates, and with widely varying quality of water including unknown salinity, unknown metal content, unknown viscosity, and unknown level of pollutants. Accordingly, the magnetic modules 508 would be tunable and subject to continual adjustment. The system 100 may be used in remote areas where spare parts may be inaccessible, and may receive what small amounts of power it needs, from solar devices or off-grid devices that have varying levels of reliability. The magnetic modules 508 will have a lot of flexibility and adjustability, both mechanically and also electronically.

Moving to FIG. 5A, within any particular recirculator, the plurality of magnetic modules 508 are arranged circumferentially about the outer surface of the tube 416 and periodically located its length. In some embodiments, a magnet pack 508 is formed with one or more static bar-magnets 509 that define opposite polarities often denoted as a North and South.

The magnetic modules 508 are arranged on an outer surface of the tube 416 in specific ways. One example arrangement is where each North pole side may be facing e.g. radially inwardly, toward the center of tube 416. In this arrangement, each South pole side of a magnet or magnet group 509 would then face radially outwardly from an outer surface of the tube 416. The specific size, shape, and orientation of the individual magnets 509 can vary. FIG. 5B shows an example magnet 509 having a non-domino shape, but that is for example only.

As shown in FIG. 2, in operation, input fluid 101 is piped into tanks 104\108 until at least partially filled. The tanks 104\108 will have a predetermined wattages applied through their respective windings 104cs\108cs for predetermined time periods, often at least 45 minutes. Often, current applied through the circumferential windings 104cs\108cs may be between 5-100 amps at a wattage between 60-1200 watts, with 100 amps at 1,000 watts being advantageous. FIG. 3B shows another way of interpreting the flow within the system 100

During use, the recirculating pumps 104p\108p move the input fluid 101 through the tanks 104\108 via the recirculators 104r\108r. These in turn apply a uniform static magnetic field to input liquid 101 via the magnets 508.

A polarity applied to the recirculator 104r may be opposite the polarity applied recirculator 108r. In one embodiment, recirculator 104r will be set with North pole sides 193 facing radially inwardly applying a total of 46,000 Gauss to input liquid 101, while the recirculator 108r will be set with South pole sides facing radially inwardly thereby applying a total of 46,000-58,000 Gauss to the input liquid 101.

Continuing this example, constant recirculation of the input fluid 101 from the tanks 104\108 through recirculators 104r\108r causes a non-transitory polar imbalance in the input liquid 101 resulting from breaking the weak dipole known to be present in water. The differences in fluid velocities within recirculators 104r\108r thus creates a separation and segregation of atomic hydrogen H₁+ within the input fluid 101.

The reactor system(s) 100 can be operated with a variety of ranges and thus have a lot of configurability and ability to be customized for specific types of production runs of the PRIF 140, and also can be adapted to specific types of input fluid 101. As stated, typically, the input fluid 101 will be a hydrogen-donating fluid such as shown in Appendix C. Further, each of the first, second, and third recirculators 104r\108r\112r can separately apply a pre-configured magnetic field to the fluid circulating therein, therefore creating a separate proton-rich vortex within each of the plurality of tanks 104\108\112. These pre-configured magnetic fields can be adjusted applied by the recirculators can be auto-adjusting. Further, if the right levels of intermediate fluids 104f\108f are occurring, the magnetic fields can be shut off entirely.

The specific magnetic field applied may vary according to characteristics of the input fluid 101. A key factor is that heterolysis (FIG. 2) occurs and breaks the covalent bonds in the water-portions of the input fluid. Subjecting the input fluid 101 to a magnetic field provides a low-cost non-CO₂-creating way of doing this.

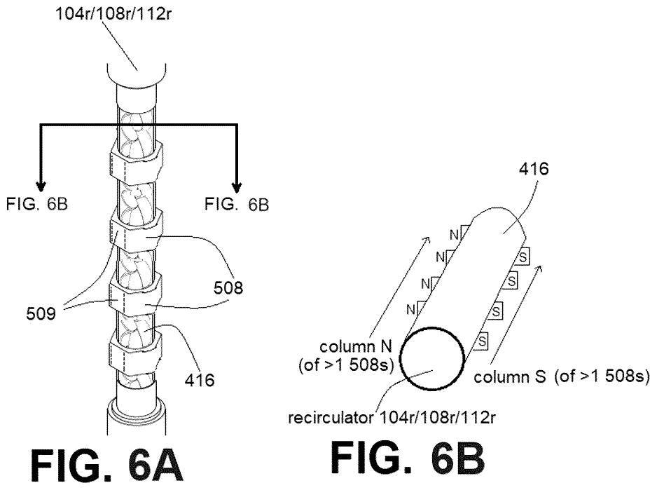

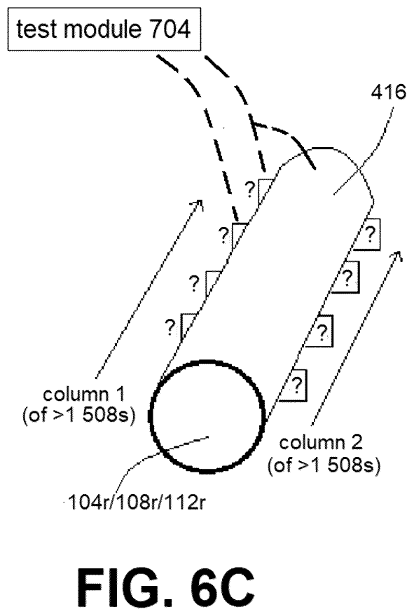

FIGS. 6A-6C show example recirculators 104r/108r/112r and FIG. 6C shows a testing module 704 that can affect production of the PRIF 140 in real-time. Under the right circumstances, the inductors of FIG. 6C can be re-oriented in a variety of patterns and polarities, hence the question-marks of FIG. 6C. The recirculator of FIG. 6C is patterned to look similar to FIG. 6B, which shows static magnets with known fixed polarities, but that is for illustration-only and the embodiments herein should not be considered as limited exclusively thereto. Instead, FIG. 6C should be interpreted to borrow from the example of FIG. 6B, but expand it to show a variety of configurations and adjustable features including not being committed to a specific polarity. The embodiment of FIG. 6C shows a test module 704 and columns of magnetic modules 508 that can be changed depending on feedback from the test module.

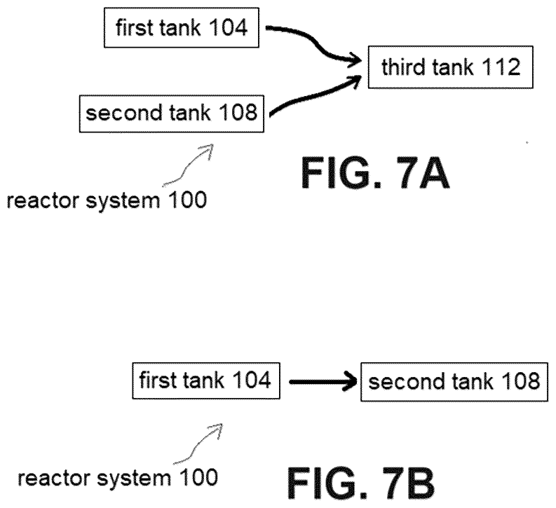

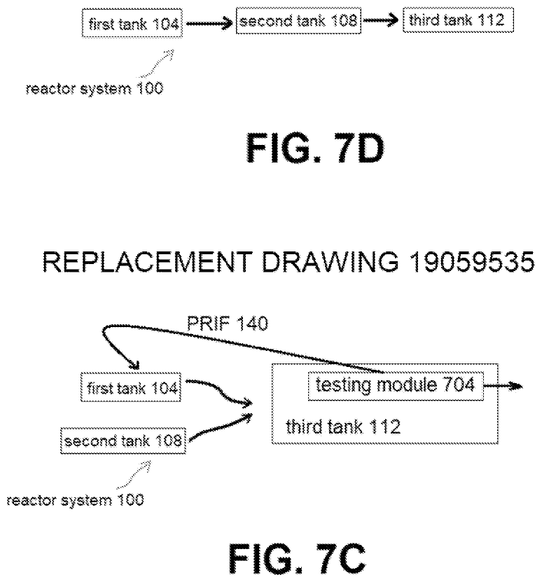

The testing module 704 of FIG. 6C and FIG. 7D can sense breaking of covalent bonds, other factors, and can adjust magnetic or electromagnetic fields and polarities in order to achieve a desired content of PRIF 140.

The testing module 704 can comprise a mass gas analyzer, ammonia or peroxide analyzers, and potentially API testing. API testing can include high-resolution mass spectrometry, liquid chromatography, high-performance thin-layer chromatography (HPTLC), and stability testing.

FIGS. 7A-7B-7C show contrasting arrangements in which potential alternate embodiments of the system 100 can include a 2-tank rather than 3-tank system 100. FIG. 7D shows another alternative routing within the system 100 including the testing module 704 that may optionally make decisions on sending fluid back to earlier tanks for further processing.

### Fake Green Hydrogen

The expression “Fake green hydrogen” refers to a situation where a company or entity claims to be producing “green hydrogen” meaning where the process requires minimal energy and gives off minimal CO₂ but is actually generating it through e.g. fossil fuels. This is essentially misleading consumers about the true sustainability of their product and also the amount of CO₂ given off. Another expression is “greenwashing” of hydrogen production.

Companies sometimes label hydrogen produced from fossil fuels as “green” to appear more environmentally friendly, to gain tax advantages, and to not reveal the amount of CO₂ given off.

It can be difficult to confirm whether a company is truly producing green hydrogen as advertised. Most hydrogen is produced in the form of H2 gas that is produced by electrolysis. Certification entities are sometimes employed to provide verification and assurance that the company is using verifiable renewable energy sources to power their electrolysis process.

In sharp contrast, when using the PRIF 140, there is no electrolysis. Second, there is no CO₂ given off. The various CO₂ monitors 150 shown in e.g. FIG. 1B would affirm that. Further, the PRIF 140 is single H₁+ not H2 gas, thus does not require cracking the H2 gas.

There exists another factor in affirming authentic green Hydrogen, meaning truly green and not “astroturf” or artificially green. This factor involves proving out that the H₂ gas was not even partially derived from SMR and Haber Bosch processes, as these both produce huge amounts of CO2. This is sometimes referred to as greenwashing. In order to seem more green, some entities hide their base-origins and hide the amount of coal burned to produce the hydrogen.

### CO2 Measurements

To address this, the system 100 features CO2 sensors 150 embedded at numerous locations within the system 100.

It is difficult to accurately measure gas contaminants. However, a single analyzer 150 for multiple natural gas contaminants can achieve accurate and reliable measurement. If necessary, the tanks can use the seal 141 to have an accurate inventory of everything given off within that specific tank. Further, the test data can be transferred in a tamper-proof way that cannot be overwritten, which is helpful for affirming authentic green hydrogen. The gas analyzer 150 is introduced mainly for CO2 detection, but can be used for many other purposes as well.

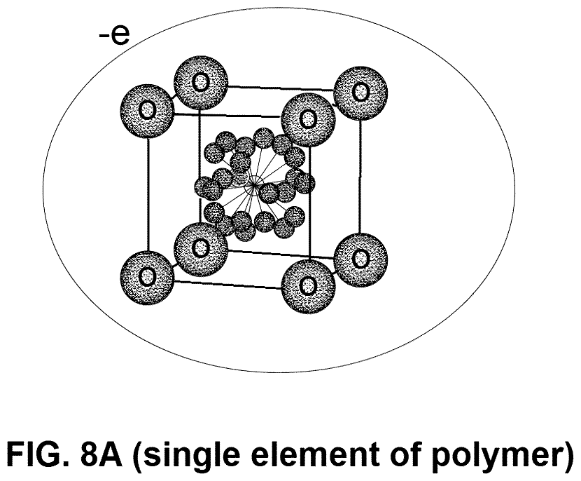

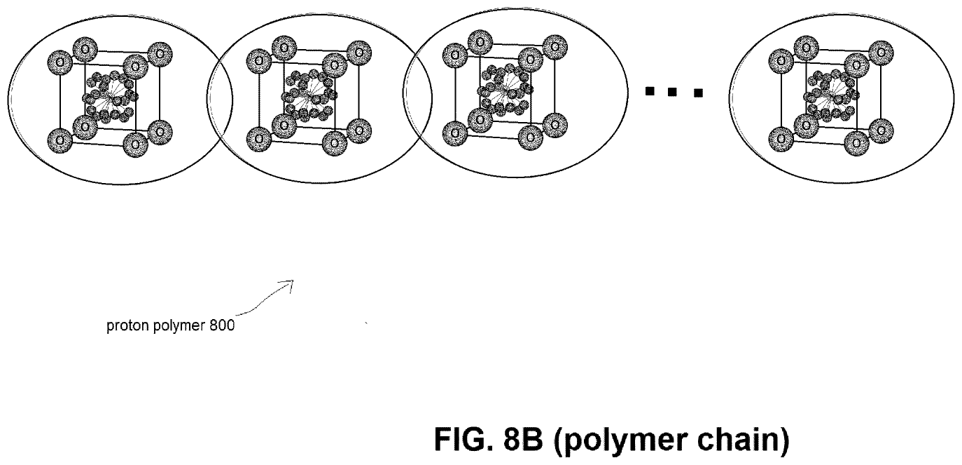

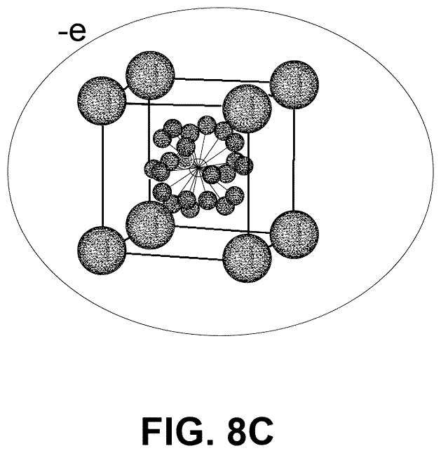

FIGS. 8A-8B show an example arrangement of the PRIF 140, this time in the form of a proton polymer 800. From FIG. 8A it is apparent that 8 oxygen atoms are positioned at 8 vertices, thereby forming a type of cubical arrangement 804. A cloud cluster of 2072 protons H₁+ is located inside of the cube 804. An electron cloud (−e 808) is shown outside the cube 804. To make the Figures clear, understandable, and relatable, the electron cloud −e 808 is shown as a simple oval, but in actuality the electrons would be far more diffused than what is visually shown in FIGS. 8A-8B.

Electrons always stay outside the cube 804, and the protons H₁+ are normally confined to the interior of the 804, until a predetermined amount of activation energy causes them to travel outside.

An alt-embodiment of the cube is shown in FIG. 8C, in which the 8 corners of the cube are not necessarily oxygen, but potentially some other type of stabilizing force.

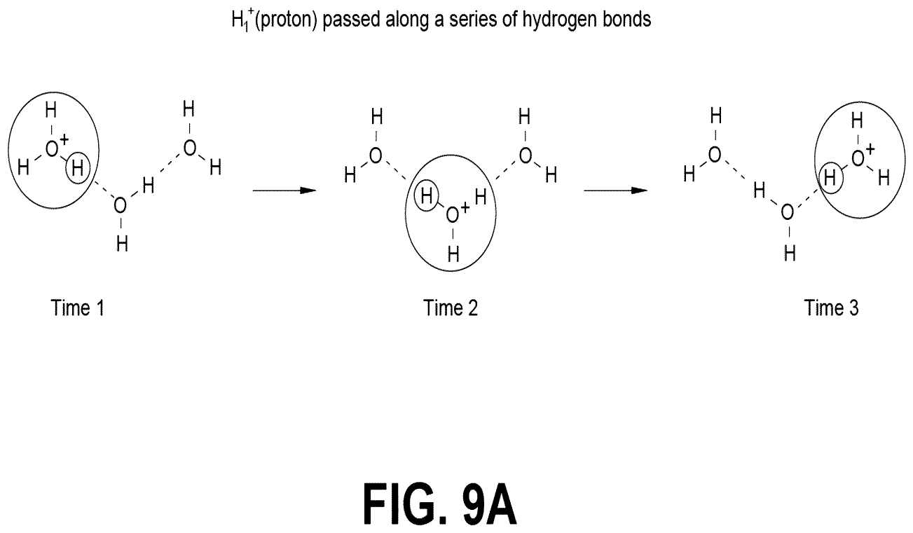

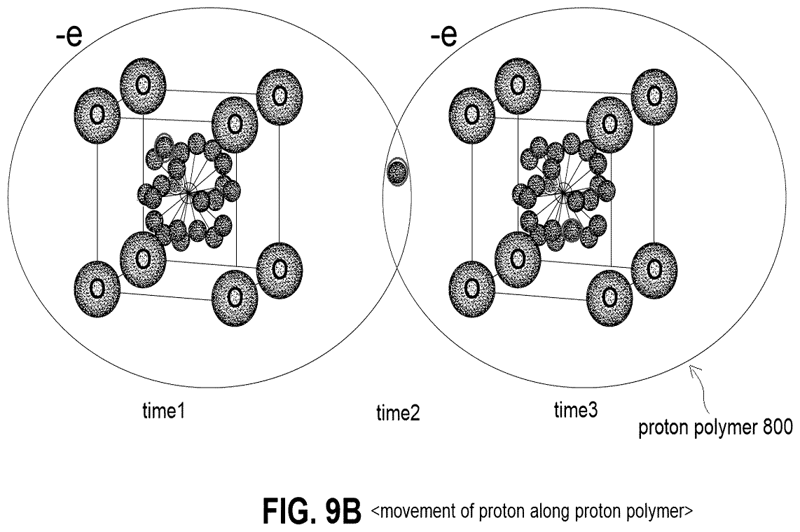

These proton travels and thresholds will be explained in more detail herein, but one brief reference to a known well-affirmed method of proton travel is shown in FIG. 9A. This example is chosen because of its simplicity, using the well-known example of common water molecules. But please note that the polymeric protonic fluid does not have any water inside of it. Thus, again, the representations of FIG. 9A and other figures are used as visual examples of travel only, with the Grothuss configuration used for convenient reference.

The proton polymer 800 has some metallic characteristics, sharing not electrons but H₁+ protons, thus creating an extensive travel path. The feasibility example of this is shown at least within FIG. 9A, in which hydrogen can advances along a chain and in this case, it advances along a condensed singular atomic hydrogen free proton chain using the known, affirmed, and accepted vehicle known as a Grothuss mechanism. This advancement of protons can be described as a “proton current”. That is, normally current is defined as the movement of electrons. However, there are recognized instances of electrical current that occurs by movement of protons, although this is less well-known.

Applying principles of Grothuss and also principles of a lattice-structure, along with proton current, Applicant's proton polymer 800 encourages the advancement of hydrogen (in the form of H₁+ protons) along the polymer chain (lattice) 800 comprising cubical arrangements 804 shown in FIG. 8B.

FIG. 9B combines the proton polymer 800 with principles of Grothuss and of metallic lattice. As stated, metallic lattices are made by the sharing of electrons between metal atoms. We only need to substitute one word. The semi-metallic lattices of the proton polymer 800 are made by the sharing of protons (not electrons) inside its fluidic state.

The novel proton polymer 800 has definite characteristics that ensure the processes illustrated herein can be objectively affirmed. The re-constructed PRIF 140 will be referenced as a super-protonic conductive polymer; this includes having a singular nomenclature formula H₅₃O, H₁₀₁O, and H₂₅₉O, and potentially other formula. These formulae are derived from its change of state from a liquid to a gas and then it is captured and processed threw a mass gas analyzer, among other evaluation resources.

As stated, the embodiments are built beginning with commonly available proton donating fluids or mixture of them (Appendix C). The specific embodiment of proton will be hydrogen H₁+ proton with no electron. it will be free of all electrons and will be concentrated no less than 93% pure hydrogen (measured by total mass) of the proton polymer 800 and the PRIF 140.

The defining characteristics and differences in the newly-constructed proton fluid are as follows:
The specific gravity shifts upward of the original proton-donor fluid (input fluid 191) to a value greater than 10%-40%;
the viscosity of proton-polymer 800 will be double that of common water. viscosity can be measured with a basic low-cost tools, e.g. a viscometer which typically measures the time it takes to for a known volume of water to flow threw a calibrated capillary tube;
the activation energy for nucleation of the protons (H₁+) will be ultra-low e.g. between 0.01 eV and 1.0 eV;
the PRIF 140 will be saturated with protons (H₁+) greater the 93% by mass;
the maximum conductivity will be between −5000 and −2000 micro siemens;
the fluid is heavily electron-deficient causing it to have a negative resistance which will invert ohms law when applying current through the polymer; and
freezing the PRIF 140 will shrink its volume by 40-50%.

In various embodiments, the following may be mixed and used with protonic conductive polymer for enhancing the multiple industrial uses including at least the following:

when the proton polymer 800 is converted into a gas it will create a hydrogen gas mass greater than 93%;
the proton polymer 800 enclosed within the PRIF 140 is stable at normal temperature and pressure;
the PRIF 140 is compatible with agitation existing fuel hydrocarbons such as diesel, fuel oils;
when used in an internal combustion engine (ICE), the polymer reduces emissions by 90% compared to common hydrocarbons;
the polymer is compatible with existing turbines;
the polymer creates a positive energy balance equation, by requiring significantly less energy to create than the amount of energy produced during use;
the hydrogen gas produced from the polymer is pure and normal (not marketing talk, this is easily verifiable using e.g. a mass gas analyzer);
the hydrogen gas produced from the polymer is compatible with existing fuel cell technology;
the hydrogen gas produced from the polymer is compatible with all stationary turbines for power production;
the hydrogen gas produced from the polymer is compatible with the Haber Bosch process to create ammonia; and
the hydrogen gas produced from the polymer is compatible with many known processes to convert oils or fuels that can be substituted for petroleum products, including e.g. Fischer-Tropsch.

From above it should be apparent the hydrogen gas produced from the proton polymer 800 (encased within the PRIF 140) is compatible with existing fuel cell technology. Fuel cells are manufactured to operate using hydrogen. Per gasification studies, the studies have shown that the PRIF 140 based on the proton polymer 800 can produce H2 gas >99% purity.

Stationary turbines are manufactured to operate using hydrogen to create deliverable electrical power. Any H2 gas produced from the proton polymer 800 is compatible with all stationary turbines.

Next, the hydrogen gas produced from the proton polymer is compatible with the Haber Bosch process to create ammonia, as well as Fischer-Tropsch process to convert oils or fuels that can be substituted for petroleum products.

Combining PRIF 140 with Conventional Fuels

The PRIF 140 based on the proton polymer 800 is compatible with existing turbines based on studies with a turbine, such as the Honeywell 100 APU Turbine Blend Test (see Appendix A). Gas turbines are inherently fuel-flexible, and can be configured to operate using hydrogen or similar fuels. Hydrogen is burned in a gas-turbine engine to generate thrust. Combustion is a chemical process in which energy is released from a mixture of fuel and air. Hydrogen's wide flammability range and high auto-ignition temperature make it particularly suitable for combustion. Applicant has affirmed using gasification studies that the proton polymer 800 (within the PRIF 140) produces hydrogen of greater than 99% purity and would therefore be compatible with existing turbines.

### Metallic Hydrogen (Language-Derivation)

This disclosure sometimes uses the expression “metallic hydrogen”. This phrase is justifiable and supportable herein for the following reasons.

Conventionally, a metal is normally defined as a solid material that is typically hard, shiny, malleable, fusible, and ductile, with good electrical and thermal conductivity (e.g., iron, gold, silver, copper, and aluminum, and alloys such as brass and steel). As such, in some ways, the various embodiments herein, e.g. the proton polymer 800, may not meet a conventional definition of a “metal”. Additionally, a traditional standard definition of a metal includes malleability, ductile, good conductor of heat\electricity, lustrous, shiny, and high tensile strength.

The above is not in dispute. However, some of these definitions have existed for hundreds of years, thus some language flexibility becomes necessary. In modern times, the word “metal” starts to shift as more is known about conduction and metallic bonding. IOW, the very definition of “metal” must be flexible and malleable (just like the metal itself).

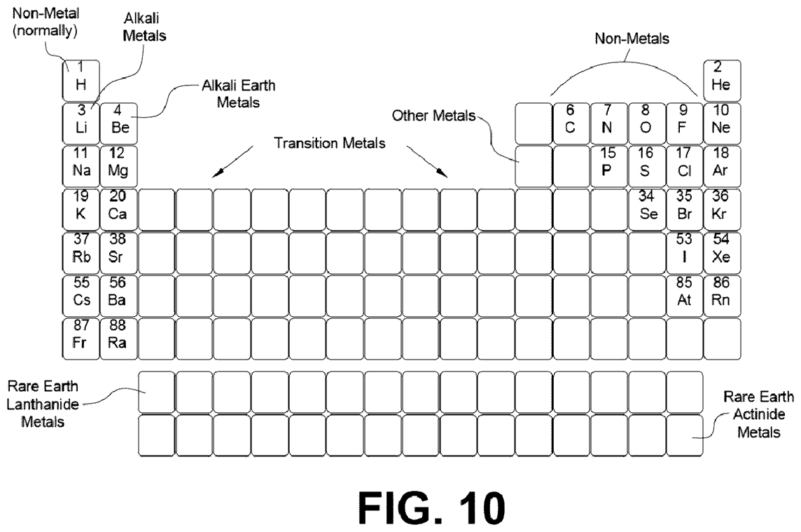

FIG. 10 shows how hydrogen is normally considered a non-metal, but sits very close to alkali metals in the periodic table. Also again helping clarify that the definition of metal must be flexible and malleable (like metal itself). So right off the bat, while traditional chemistry may not recognize hydrogen as a metal per se, certainly hydrogen is long-recognized as being “metal-adjacent”. Under the right circumstances, a hydrogen-based fluid can be forced to behave as if it had semi-metallic properties, thus a type of “metallic hydrogen”.

Though placed at the top of the alkali metal column in the periodic table, hydrogen does not exhibit the properties of an alkali metal (under ordinary conditions). Instead, hydrogen forms diatomic H2 molecules, similar to halogens and some nonmetals in the second column of the periodic table, such as nitrogen and oxygen. Unfortunately, diatomic hydrogen (H2 gas) liquefies and solidifies only at very low temperature (20° K and 14° K respectively). This makes working with conventional liquid hydrogen very cost-prohibitive. The embodiments of PRIF 140 herein provide a better way.

Next, in 1935 and maybe earlier, scientists started speculating about the existence of a metallic hydrogen in some format. Eugene Wigner stated that at high pressure and temperatures, metallic hydrogen can exist as a partial liquid rather than a solid. Even in 1935 researchers had good reason to believe metallic hydrogen (in some format) was present in large quantities in specific areas.

Applicant's use of metallic hydrogen can be defined as making use of a lattice structure, and also adapting a Grothuss mechanism shown in FIG. 9A.

FIG. 9A when read with FIG. 9B provide support that the PRIF 140 also has its own quasi-Grothuss type of behavior, which in turns supports the language-usage of metallic hydrogen. Specifically, under the right circumstances), with the proper levels of activation energy (e.g. 0.2 volts, or zero-voltage using e.g. a heated iron source), Applicant's H₁+ protons begin tunneling and re-positioning themselves outside of their base location. The structure of the PRIF 140 facilitates this movement, such that the H₁+ protons become easier and easier to release. This in turn means that the reforming discussed herein occurs in an exponential (logarithmic) rate, and not just linear.

Ionic lattices are formed by the attraction between positive and negative ions. Covalent lattices happen when atoms share electrons. Applicant also contemplates Proton Coupling Electron Transfer (PCET). One advantage of PCET is that an electron and a proton both move at the same time. They happen at the same time which is helpful in a process of reforming the PRIF 140.

Metallic lattices are made by the sharing of electrons between metal atoms. The proton polymer 800 has some metallic characteristics, sharing not electrons but H₁+ protons, over an extensive travel path. The feasibility of this is shown at least within FIG. 9A, in which hydrogen advances along a chain of protons using the known, affirmed, and accepted vehicle known as a “Grothuss mechanism”. This advancement of protons can be described as a “proton current”. That is, normally current is defined as the movement of electrons. However, there are recognized instances of electrical current that occurs by movement of protons, although this is less well-known.

Applying principles of Grothuss and also principles of a lattice-structure, Applicant's proton polymer 800 encourages the advancement of hydrogen (in the form of H₁+ proton) along the polymer chain (lattice) 800 comprising cubical arrangements 804 shown in FIG. 8B.

FIG. 9B combines the proton polymer 800 with principles of Grothuss and of metallic lattice. As stated, metallic lattices are made by the sharing of electrons between metal atoms. Modernizing Grothuss to apply to the PRIF 140, one need only substitute a single word. The semi-metallic lattices of the proton polymer 800 are made by the sharing of protons (not electrons).

Regarding the structures of FIGS. 8A-8B, the cubical arrangement (cage) 804 formed by the eight oxygens acts as a type of confinement cell, where the hydrogen atoms (in the format of H₁+ protons) inside cannot escape the cubical arrangement 804. At least, not until a predetermined amount of activation energy reaches the cubical arrangement 804. In an embodiment, the H₁+ protons inside the cubical structures are all aligned spinning in a symmetrical nuclear spin state. This can be affirmed through use of a Relativistic Heavy Ion Collider (RHIC).

Referring again to events of 1935, at that time physicists Eugene Wigner and Hillard Bell Huntington predicted that hydrogen could display metallic properties: instead of discrete H2 molecules (which consist of two electrons bound between two protons), a bulk phase could form having a solid lattice of protons and the electrons delocalized throughout. The embodiments herein are one example of this prediction.

As stated earlier, freezing the PRIF 140 will shrink its volume by 40-50%. Freezing the PRIF 140 (containing the proton polymer 800) proves that the PRIF 140 has no water remaining therein. One way to affirm this is that ordinary water expands during freezing, and is clearly visibly enlarged. Meanwhile, the PRIF 140 does not have water, and in fact shrinks during its frozen state. This is a big difference, very easily measured by even primitive instruments.

A freezing point for PRIF 140 might be 19° F.-28° F., and can be done with common household food freezer. This freezing and measuring demonstrates that even though PRIF 140 started with nearly 95% water, the reactor-process achieves a total conversion to a different material. This also proves PRIF 140 is not just adding an electrolyte to water, or a compound water formula. Instead, the PRIF 140 is completely changed. One description of PRIF 140 might be a metallic protonic super hydride.

Another reason for freezing the PRIF 140: doing so increases its conductivity by naturally making the material more dense, and further illustrates the position that PRIF 140 is a type of metallic substance, e.g. metallic hydrogen. Likes with all other metals, PRIF 140 shrinks upon freezing, rather than expanding.

Some application of the PRIF 140 e.g. extreme harsh weather (Alberta, Canada North) the cold solid state still maintains the claimed attributes of its liquid state. This could be very beneficial to those environments, as the PRIF 140 would not need to be preserved in a warm state.

If any H2O was left behind there would be an expansion, or even a separation or cracking, which has not been observed. Also, unlikely other materials, freezing does not shear the PRIF 140 into different components which happens to many compounded products. This again proves creation of a completely new material.

Regarding reforming (converting to gas from earlier state), one can still gasify the solid block of PRIF 140 and convert or sublimate to H2 gas. This suggests stability in changing state from e.g. liquid to solid, liquid to gas, or solid to gas. A stable state shift in a new material especially one formed with metallic hydrogen.

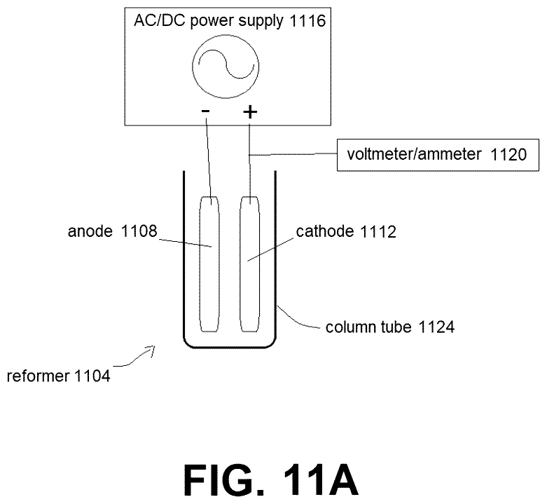

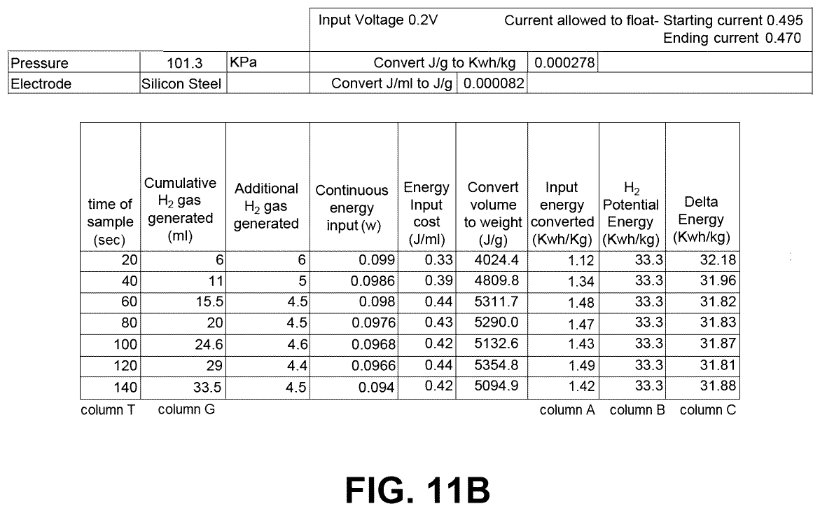

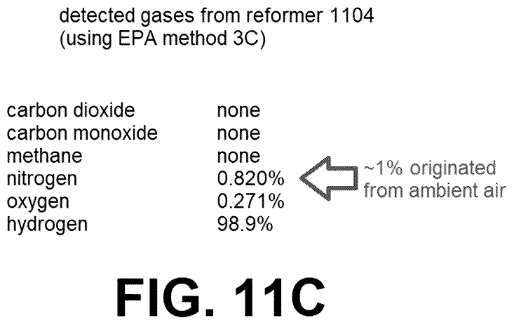

FIG. 11A shows a simplified reformer 1104 for reforming PRIF 140 into H2 gas with no separated gas stream it is all collected in on stream of gas. This visual representation is for example only, and the various embodiments of reformer 1104 discussed herein should not be considered as limited exclusively thereto. The reformer 1104 comprises a column tube 1124 containing two electrodes, an anode 1108 and cathode 1112 connected to an AC or DC power supply 1116. During use, the reformer 1104 is filled with a predetermined amount of PRIF 140, and known amounts of electricity are applied to the anode/cathode 1108/1112 under timed circumstances. Within the reformer 1104, both electrodes are made from silicon steel.

In conventional systems e.g. Hoffman apparati, typically there would be only oxygen (no hydrogen) created on any anode and the gas streams would be separated. Meanwhile, the reformer 1304 gets hydrogen from both electrodes.

During use of the reformer 1104, electricity was supplied to the electrodes 1108/1112, which generates gas. The total unseparated captured gas stream was pushed through a mass gas analyzer (not shown) which captured all gas produced at both the cathode and anode electrodes. An embodiment applied 0.2 volts and 0.49 amps for 20 seconds (see FIG. 11B). This resulted in a hydrogen composition of 98.9%, thereby showing that even with common AC or DC power, there is no oxygen being reformed, only hydrogen.

Although not shown in FIG. 11A, there exists a special type of capture-bag to put the gas into, and then run it through a GC mass spec.

FIG. 11B conveys that the embodiments herein can affirm and verify that hydrogen gas is captured at the both anodes and cathodes of the reformer 1104. The measurements within FIG. 11B also convey that the PRIF 140 combined with the reformer 1104 can produce ~22X energy gains. This is achieved by taking a number in column B and dividing it by its corresponding number in column A. The numeric result will be in the range of 22.

Next, any reasonable person (e.g. a POSITA) may not believe that the anode 1108 was making hydrogen (not oxygen), as this is counter-instinctive. Any conventional Hoffman apparatus would have the anode making oxygen-only, going back to when Augustus Hoffman began doing electrolysis of water in 1866. However, for anyone reading this disclosure that may believe there was still oxygen being produced at the anode 1108, FIGS. 11B-11C show how this is not possible, several different ways.

First, electrolysis is inefficient, energy-eating, and could never be achieved applying on 0.2V. Second, ordinary water with a hydrogen mass of only 11% is not under consideration here, as the PRIF 140 has components that water does not have, thus conventional Hoffman processes are irrelevant. Third, FIG. 11C shows the total gases produced by the reformer 1104. Such production would never be the result in a combined gas stream of an ordinary electrolysis process.

FIG. 11C is an analysis of all gases produced by the reformer 1304. Its preferable to gas-analyze the reformed hydrogen, due to the trustworthiness and reliability of mass gas analyzers. FIGS. 11B-C effectively prove that both anode and cathode are creating hydrogen. This is possible because the reformer 1104 is not doing electrolysis. FIG. 11C show that there's a 1% air potential for a mis-measurement due to air in the chamber.

FIGS. 11A-B-C also affirm non-electrolysis another way. During the reformation process, the voltmeter 1108 stayed right around 0.2 volts the entire time, which is below any threshold for a successful water-based electrolysis reaction. This proves there exists no diminishment in delta energy creation, and shows excellent net energy gain throughout the whole system.

FIG. 11B shows other important data. From the time of 20 seconds all the way to 140 seconds (column T) and from 6 ml all the way to 33 ml (column G), FIG. 11B shows there always existed a ~22× energy gain. This is obtained by dividing the number in column B by its corresponding number in column A, and doing so repeatedly, every 20 seconds.

FIG. 11B also shows that the PRIF 140 reaction is not diminishing over time. This is noticeable by viewing column T (time) and column G (gas generated). That in turn affirms that the PRIF 140 is not a mere carrier, it is liquid atomic hydrogen (albeit in a specialized format).

Hydrogen gas yields is 33.3 kilowatt hours per kilogram. Electrical energy cost was ~1.5 kilowatt hours. The reformed H2 gas obtained was >98% hydrogen. Accordingly, it is possible to reform hydrogen where a resulting hydrogen H2 gas volume can contain as much as 22X potential energy as the original amount of energy applied to the PRIF 140.

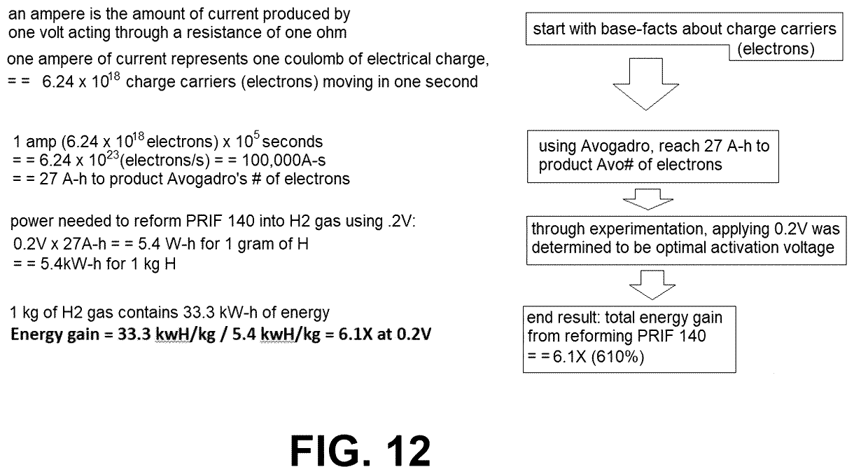

FIG. 12 shows more detail about affirming positive energy balance of the PRIF 140 containing the proton polymer 800. Specifically, the PRIF containing the proton polymer 800 creates a positive energy balance, by requiring significantly less energy than the amount of energy produced.

FIG. 12 shows the steps in computing amount of energy needed for creation of 1 kg of H2 gas from the PRIF 140. For computation purposes, FIG. 12 uses a voltage supply as an energy source, as opposed to heat, or heated re-bar, or other energy source which also work within the embodiments herein.

In FIG. 12 it is apparent that an optimal voltage to achieve activation energy was 0.2 volts. Bearing this in mind, it becomes apparent that reforming for 27 amp-hours is suitable to make 1 Kg of hydrogen gas.

The PRIF 140 can react effectively using as low as 0.2 volts activation energy, and maybe lower. This is sometimes referred to as “activation voltage” and/or “activation energy”. FIG. 12 shows how many electrons are in each one of those potentials showed what the potential lowest energy capability is. A worst case scenario, with no outside help, one would need five kilowatt hours per kilogram to make one kilogram of H2 gas. A worst case scenario would have a 6× value.

The PRIF 140 could actually reform at 0.01 volts, although this would be kind of slow, probably not-optimal when high volume production of H2 gas is needed. The point of FIG. 12 is more to show reforming capability. Many remote or adverse locations have limited power available. A low-power low-voltage way of creating energy-rich H2 gas would still have great value, even if (at times) the H2 gas reaction runs a bit slow.

Further exemplary embodiments and explanations are provided as follows. These examples and embodiments may provide further information or support for other processes or embodiments shown and described due to the novelty of the changes done to the electrical characteristic of the protonic polymer.

### DISCLAIMER

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

### APPENDIX A: TESTING MECHANISMS AND NON-LIMITING TEST-RESULTS

Inductively Coupled Plasma Mass Spectrometry Test

| Properties | Units | Amount |
|---|---|---|
| Conductivity (25° C.) | mS/cm | 1,500,000.00 |
| Resistivity (25° C.) | Ω*m | 0.01 |

An inductively coupled plasma mass spectrometry study of the PRIF 140 containing the proton polymer 800 is shown above.

Maximum Conductivity Test

| Samples | Units (milli Siemens) | Amount |
|---|---|---|
| #1 (25° C.) | mS | −4100 |
| #2 (25° C.) | mS | −3500 |
| #3 (25° C.) | mS | −3000 |

From above it is apparent that the maximum conductivity of the PRIF 140 based on the proton polymer 800 is negative, thus indicating a negative resistance, thereby in turn indicating an extremely low activation energy. The expression “negative resistance” is often synonymous with ultra-high conductivity, which is an important feature of the embodiments herein.

### Tests Involving Combined Fuels

As stated earlier, the PRIF 140 based on the proton polymer 800 is compatible with existing fuel hydrocarbons such as diesel, fuel oils, etc. In common practice, the hydrogen used for hydrocarbon refinement is in a gaseous phase. The use of gaseous hydrogen upgrades the fuel, improves efficiency, and reduces emissions. The PRIF 140 based on the proton polymer 800 is compatible with the hydrocarbon refinement process and saturates the fuel, allowing hydrogenation to occur without the need for gaseous hydrogen.

Such hydrogenation of a base-fuel causes a higher concentration of hydrocarbons, resulting in a more efficient burn and a 30%-90% reduction in emissions (e.g. SOX, NOX, CO2).

Combined Fuel Emission Tests of proton polymer 800

| Diesel (ULSD) | 30% proPolymer | 50% proPolymer | 75% proPolymer |
|---|---|---|---|
| SOX 10/10 | 6/10 | 4/10 | 1/10 |
| NOX 10/10 | 6/10 | 4/10 | 1/10 |
| CO2 10/10 | 6/10 | 4/10 | 1/10 |

As shown above, when used in an internal combustion engine (ICE), the PRIF 140 containing the proton polymer 800 can reduce emissions by as much as 90% when combined with well-known hydrocarbon-based fuels such as diesel. The chart above depicts the emission ratings (1-10 of ultra-low sulfur diesel (ULSD) and the PRIF 140 containing the proton polymer 800.

The ratings within the above chart are based on a 0-10 scale, with 0 being the lowest emissions and 10 being the highest emissions. The un-altered diesel referred to above is found to have the highest emissions.

Finally, the specific diesel formulations referred to above included either included CAT 10% RR2/90% Diesel Blend Test or a CAT 20% proton fluid/80% Diesel Blend Test.

### APPENDIX B: POLICING INFRINGEMENT OF PROTON POLYMER CLAIMS

To enforce claims on the proton polymer 800, it is important to identify which instrument can best affirm this. Helpful to test the PRIF 140 for any fingerprint or characteristics that could not have been produced any way other than by the claims herein.

The intention is to assert “this is our cubical structure and this instrumentation proves another product matches with the claims herein. That would likely start with least three mechanisms: NMR, conductivity meter, and a mass gas analyzer (MGA).

The MGA would be helpful to break down Applicant's signature cube structure, cubical fingerprint of the proton polymer 800 (see FIGS. 8A, 8B, 9B). Thus, a 3-instrument suite for detecting infringement would be a good place to start, one of which unfortunately involves conversion to gas.

A fourth might be to verify electron spin, which might involve Relativistic Heavy Ion Collider (RHIC).

Moving to secondary infringement detection, some 5th-8th devices might include measuring for differential resistance, comparing weight, comparing viscosity, and/or comparing specific gravity. These are better because they cost less, and tests can be run quickly, and all can be done in a liquid-only format. These mechanisms are B-team mainly because they don't fully show an entire fingerprint, but indicate hints and trends. Thus, a changeable suite of instruments could be used to at least narrow down a true authentic fingerprint of the proton polymer 800.

Moving back to MGA, one suitable MGA analyzer could be an inline GC-Mass Spec device. These can do analysis of the mass gases produced, which would then prove that the cube-fingerprint is present. The cube-fingerprint could be proven or at least induced by the density of the composition of its gas. A problem would be that GC-mass Spec devices are expensive, time-consuming, and not really portable. Applicant would prefer something that could be used quickly, without a lot of people noticing, and produces trustworthy reliable results.

The equipment should show that protons don't naturally stay in an available format, in a fluid, without these types of cubical structures. Strive for a liquid-only non-gas way of detecting cube-infringement. It would be a nice option to stick a dipper into a suspected liquid. Avoid converting it to gas in order to prove infringement. There is a way to do this with liquid.

However, applicant also contemplates a small portable gasifier that can be carried in a car, has a port for connection to a laptop for display and operation. Also some type of portable small Hoffman chamber, even if power-inefficient. Use a car-battery or jump-box that produces big current for short periods of time, and then can be re-charged. Only small amounts of any fluid would be needed, for either proving or dis-proving the cubical fingerprint of the PRIF 140.

NMR is helpful because it can show delocalized electrons, which would show that our bonds are not only ionic and covalent, but also metallic and the key part of a metallic bond chemistry is that the electrons are delocalized. NMR may also be available to find delocalized protons (H₁+). A basic Hoffman apparatus could put the fluid into a mono-stream at the end connected, two ends together and run it through an MGA analyzer. Convert this into a portable version that can tested on-site, e.g. at tank-side, at railcar-side.

The activation energy of PRIF 140 is helpful here. This activation energy being near 0.02 volts occurs because the proton and the electron are moving at the same time, which reduces delay. In the absence of Grothuss mechanisms, protons are actually hard to move. So the fact of moving them at the same time, gets close to moving a proton at the same speed of an electron. Meanwhile, electrons are one of the few subatomics that can actually achieve the speed of light.

Any unknown fluid having that same activation energy within that range with a hydrogen stream greater than 90 percent, that would start to look suspicious. The activation energy of PRIF 140 and the proton polymer 800 wouldn't go higher than 1.2 volts. The reason why is at 1.2 volts is the known limit. So as long as below, 1.2 volts all the way to 0.02 volts, that is unique. Thus, our claims strive to include a fingerprint that looks like this. The fingerprint must be unique, unlikely to exist by accident. Activation energy might be one helpful criteria.

### APPENDIX C (NON-LIMITING LIST OF POTENTIAL HYDROGEN-DONATING FLUIDS)

HCl—hydrochloric acid; HNO3—nitric acid; H2SO4—sulfuric acid;
HBr—hydrobromic acid; HI—hydroiodic acid; HClO4—perchloric acid;
HClO3—chloric acid; HO2C2O22H—oxalic acid;
H2SO3—sulfurous acid; HSO4—hydrogen sulfate ion;
H3PO4—phosphoric acid; HNO2—nitrous acid; HF—hydrofluoric acid;
HCO2H—methanoic acid; C6H5COOH—benzoic acid;
CH3COOH—acetic acid; HCOOH—formic acid; C6H8O7—citric acid;
C18H36O2—stearic acid; CH3OH—methyl alcohol;
CH3CH2OH—ethyl alcohol; CH3(CH2)3OH—n-butyl alcohol;
C3H8O—propanol; CH3CH2CH2OH—n-propyl alcohol;
(CH3)3COH—t-butyl alcohol; CH3(CH2)4OH—n-pentyl alcohol;
(CH3)2CHOH—isopropyl alcohol;
H2O—water (all water types, grey, produced, effluent, industrial, deionized, distilled) CH4N2O—Urea;

### General Metal Salts:

Sodium Hydroxide, Calcium Hydroxide, Magnesium Hydroxide, Lithium Hydroxide, Magnesium Oxide, Calcium Oxide

### APPENDIX D: SPECIFICATION NOT CLAIMS

(a B-Team Listing of Subject Matter that May be Useful for Later Claiming)

### Potential Method Sequence

applying an electrostatic and magnetostatic force to a zone 1;
mixing a proton donor and water at a predetermined rate through a recirculator;
the recirculator having a first strong magnetic force applied thereto;
applying a magnetostatic force to a zone 2;
mixing a proton donor and water at a predetermined rate through a recirculator;
the recirculatory having a second strong magnetic force applied thereto;
wherein the second magnetic force is opposite to the first;
configuring zone 2 to be twice the volume of zone 1;
filling zone 2 to half its set volume, thereby allowing the contents of zone 1 to fully mix in zone 2;
zone 2 completing its processes in a second predetermined time period;
the contents of zone 2 pumped through a hydrocyclone thereby removing any precipitated non-soluble solids into a settling tank (zone 3);
hydrocyclone goes into a settling tank (zone 3), and the settling tank having a filter;
after a 3rd predetermined time period, putting highly protonic polymer into a storage tank (zone 4).
XX. the polymer of claim 1, further comprising:
   the H₁+ protons inside the cubical structure are either spinning up or spinning down since they are all atomic hydrogen only
XX. the proton polymer of claim 1,
   the proton polymer is created from a cloud of hydrogen atoms
XX. the proton polymer of claim 1,
   the material created is a fluidic state of metallic hydrogen
XX. the proton polymer of claim 1,
   the material has de-localized electrons

What is claimed is:

1. A proton polymer having a predetermined shape, comprising:
two or more cubical structures each having 8 oxygen atoms which form the 8 corner-boundaries of the cubical structure;
an electron cloud which orbits only the outside of the cubical structure;
the two or more cubical arrangements forming one or more polymer chains;
the one or more polymer chains being suspended within a water-soluble fluid; and
each of the plurality of H₁+ protons floating freely within a respective cubical arrangement, but not leaving the interior of any particular cubical arrangement until an activation energy having a predetermined threshold is applied to that cubical arrangement.

2. The polymer of claim 1, further comprising:
the water-soluble fluid being a proton-rich ionic fluid.

3. The polymer of claim 2, further comprising:
the activation energy being applied for the purpose of generating H2 gas.

4. The polymer of claim 3, further comprising:
the activation energy originating from a saturated electron source.

5. the polymer of claim 2, further comprising:
the combination of H₁+ clusters inside the cubical structures causing the proton polymer to have an activation energy between 0.01 eV and 1.0 eV.

6. The polymer of claim 2, further comprising:
the cluster of H₁+ protons having no neutrons.

7. The polymer of claim 2, further comprising:
the electron cloud being de-localized and never going inside the cubical structure.

8. The polymer of claim 2, further comprising:
the cubical arrangement causing an elevated negative ion conductivity within the proton polymer.

9. The polymer of claim 8, further comprising:
the elevated negative ion conductivity causing an elevated negative resistance.

10. The polymer of claim 8, further comprising:
affirming the negative ion conductivity using ion chromatography.

11. The polymer of claim 1, further comprising:
at temperatures above predetermined thresholds, the various H₁+ protons spreading out within their respective cubical arrangement but not moving outside the cubical arrangement, thereby forming an aqueous proton transport mechanism.

12. The polymer of claim 11, further comprising:
the aqueous proton transport mechanism being a Grothuss-mode of proton transport.

13. The polymer of claim 2, further comprising:
when frozen, the proton polymer reducing its volume by 30-40%.

14. The polymer of claim 13, further comprising:
when frozen, the proton polymer ranging between 0° C.-4° C.

15. the polymer of claim 2, further comprising:
when outside electron power source is applied to the proton polymer, the proton polymer converting into a gas measuring >=93% H2 by mass.

16. the polymer of claim 15, further comprising:
once in the gas state, the proton H₁+ do not stay inside the cubical structure but instead pair with other H₁+ protons to form H2 gas.

17. the polymer of claim 16, further comprising:
once in the gas state, the proton H₁+ not pairing up with any electron but instead only pairing up with other H₁+ protons to form H2 gas.

18. the proton polymer of claim 18, further comprising:
the proton polymer having a range between H₅₀O and H₂₅₉O.

19. the proton polymer of claim 18, further compromising:
the proton polymer being reformable to a range of 90%-99% H2 gas by mass.
